(19) United States
(12) Patent Application Publication
(10) Pub. No.: US 2025/0225462 A1
(43) Pub. Date: Jul. 10, 2025

(54) PRIVACY RISK MANAGEMENT PLATFORM

(71) Applicant: Privacy Bee, LLC, Roswell, GA (US)

(72) Inventor: Harry Maugans, Roswell, GA (US)

(21) Appl. No.: 18/404,996

(22) Filed: Jan. 5, 2024

(51) Int. Cl. G06Q 10/0635; G06Q 10/0639

(52) U.S. Cl. CPC G06Q 10/0635; G06Q 10/06393; G06Q 10/06395

(57) ABSTRACT

A privacy risk platform determines, for an organization, a list of one or more vendors, and a list of all organization employees. For each vendor on the vendor list, the platform determines a vendor employee list comprising a subset of the vendor employees. For each employee in the vendor employee list, the platform calculates an exposure score associated with the vendor employee. The platform calculates a vendor score for the vendor based on the scores of each vendor employee in the vendor employee list. For each organization employee, the platform determines an exposure score associated with the employee. The platform calculates an organization score, representing a risk of exposure of confidential information associated with the organization online, based on the scores of each organizational employee. The platform provides a report comprising at least one of the organization score, the vendor scores, and the organizational employee scores.

### FIELD OF DISCLOSURE

The present disclosure generally relates to privacy risk management, and particularly to quantifying and managing the risk of a privacy breach at an organization, based at least in part on privacy risks associated with vendors that service the organization and privacy risks of organizational employees.

### BACKGROUND

In some situations, an organization may seek to monitor, quantify, and manage a privacy risk associated with the data maintained at the organization. For example, various governmental regulations may require privacy monitoring and/or management. Additionally, consumers may be desirous of companies with a robust privacy management to protect customer data.

Privacy risk management is a risk management framework for determining the risk of holding and maintaining Personal Identifiable Information (PII). Organizations can make informed decisions to prevent privacy-related mistakes by conducting privacy risk assessments. This ensures businesses comply with privacy regulations and can accommodate data privacy requests from consumers and authorities. As a result, companies that conduct privacy risk assessments are more likely to avoid legal and business implications of non-compliance and to build a long-term, trustworthy relationship with their customers.

One way that an organization can control privacy risk is by selecting vendors with a low risk of a data breach. As an example, if an organization works with (e.g., is serviced by) a vendor, and the vendor has employees with exposed PII, this puts the vendor at a risk of getting breached (e.g., by spear phishing, social engineering, or other related attacks, etc.). If the vendor gets breached, the hacker that caused the breach may be able to leverage the trusted relationship between the vendor and the organization(s) serviced by the vendor, to potentially breach those organizations too. Thus, an organization has an interest in proactively monitoring its external vendors for External Data Privacy risks.

Accordingly, there is a need for a platform to track privacy risks of individual organizational employees and with vendors who service the organization.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A privacy risk management platform may be used to monitor privacy risk for an organization based at least in part on privacy risk associated with organizational employees. In particular, where data associated with an employee is exposed online (e.g., maintained or stored at one or more online data repositories), the data may be used in so-called “spear phishing” attempts that leverage data related to the employee in to send messages that appear to be legitimate an attempt to acquire sensitive information or access to a computer system. The data may also be used in various social engineering tactics to obtain information or other related attacks. Further, the privacy risk of the organization may be related to privacy risks of vendors that service the organization. In turn, those vendor privacy risks are based in part on privacy risks of the vendor employees, as described above.

In embodiments, a privacy risk platform may include, systems, methods, and/or computer program products that determine, for an organization, a vendor list comprising one or more vendors working with the organization, and an organizational employee list comprising all organization employees.

For each particular vendor on the vendor list, the platform may populate a vendor employee list comprising a subset of the employees of the particular vendor. For each vendor employee in the vendor employee list, the platform may calculate an exposure score associated with the vendor employee. The exposure score may be a qualitative or quantitative indicator of an exposure of personal information of the vendor employee online. The platform may calculate a vendor score for the particular vendor, the vendor score representing a (qualitative or quantitative) risk of a privacy breach for the vendor. The vendor score may be determined based on at least the scores of each vendor employee in the vendor employee list. In some embodiments, additional factors, such as (but not limited to) a privacy policy associated with the vendor, factors associated with prior privacy breaches of the vendor (e.g., recency of the breach, the type and/or quantity of information exposed, etc.), and the like may also be considered when determining the vendor score.

For each organization employee in the organizational employee list, the platform may determine an exposure score associated with the organizational employee. The exposure score may be a qualitative or quantitative indicator of an exposure of personal information of the organizational employee online.

The platform may calculate an organization score representing a qualitative or quantitative risk of a privacy breach of the organization. The organization score may be calculated based at least in part on the scores of each organizational employee in the organizational employee list. In some embodiments, additional factors such as (but not limited to) a privacy policy associated with the organization, factors associated with prior privacy breaches of the organization (e.g., recency of the breach, the type and/or quantity of information exposed, etc.), scores associated with one or more vendors servicing the organization, and the like may also be considered when determining the vendor score. In some embodiments, the organization score may be used as a vendor score for a company that relies on the organization as a vendor.

In a first embodiment, the platform may provide a method, system, and/or computer program product configured to determine, for an organization, a vendor list comprising one or more vendors working with the organization, and an organizational employee list comprising at least a subset of the organization employees. For each particular vendor on the vendor list, the platform may populate a vendor employee list comprising at least a subset of the employees of the particular vendor, calculate, for each vendor employee in the vendor employee list, an exposure score associated with the vendor employee, the exposure score being indicative of an exposure of personal information of the vendor employee online, and calculate a vendor score for the particular vendor, the vendor score representing a privacy and security risk associated with the vendor online, the vendor score being determined based at least in part on the scores of each vendor employee in the vendor employee list. For each organizational employee in the organizational employee list, the platform may determine an exposure score associated with the organizational employee, the exposure score being indicative of an exposure of personal information of the organizational employee online. The platform may calculate an organization score representing a privacy and security risk associated with the organization online, the organization score being determined based at least on the scores of each organizational employee in the organizational employee list. Finally, the platform may provide, to a user, a report comprising at least one of: the organization score, the organizational employee exposure scores or one or more of the organizational employees on the organizational employee list, and the vendor scores of one or more of the vendors on the vendor list.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment of a privacy risk management platform consistent with the present disclosure;

FIG. 2 is a flow chart of a method for providing a privacy risk management platform;

FIG. 3A is a first example interface provided as part of the operation of the privacy risk management platform;

FIG. 3B is a second example interface provided as part of the operation of the privacy risk management platform; and

FIG. 4 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of privacy risk evaluation, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

A privacy risk management platform may be used to monitor privacy risk for an organization based at least in part on privacy risk associated with organizational employees. In particular, where data associated with an employee is exposed online (e.g., maintained or stored at one or more online data repositories), the data may be used in so-called “spear phishing” attempts that leverage data related to the employee to send messages that appear to be legitimate an attempt to acquire sensitive information or access to a computer system. The data may also be used in various social engineering tactics to obtain information or other related attacks Further, the privacy risk of the organization may be related to privacy risks of vendors that service the organization. In turn, those vendor privacy risks are based in part on privacy risks of the vendor employees, as described above.

Embodiments of the present disclosure may comprise methods, systems, and a computer readable medium comprising, but not limited to, at least one of the following:
A. A Vendor List Aggregation Module
B. An Employee List Aggregation Module
C. An Employee Exposure Score Calculation Module
D. A Business Privacy Risk Score Calculation Module

In some embodiments, the present disclosure may provide an additional set of modules for further facilitating the software and hardware platform. The additional set of modules may comprise, but not be limited to:

### E. An Artificial Intelligence Module

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components as found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
determining, for an organization:
   a vendor list comprising one or more vendors working with the organization, and
   an organizational employee list comprising all organization employees;
for each particular vendor on the vendor list:
   populating a vendor employee list comprising a subset of the employees of the particular vendor,
   calculating, for each vendor employee in the vendor employee list, an exposure score associated with the vendor employee, the exposure score being indicative of an exposure of personal information of the vendor employee online, and
   calculating a vendor score for the particular vendor, the vendor score representing a risk of exposure of confidential information associated with the vendor online, the vendor score being determined based on:
      the scores of each vendor employee in the vendor employee list, and
      optionally, additional factors such as a privacy policy associated with the vendor, factors associated with prior privacy breaches of the vendor (e.g., recency of the breach, the type and/or quantity of information exposed, etc.), and/or the like;
for each organizational employee in the organizational employee list:
   determining an exposure score associated with the organizational employee, the exposure score being indicative of an exposure of personal information of the organizational employee online;
calculating an organization score representing a risk of exposure of confidential information associated with the organization online, the organization score being determined based on:
   the scores of each organizational employee in the organizational employee list, and
   optionally, additional factors such as a privacy policy associated with the vendor, factors associated with prior privacy breaches of the vendor (e.g., recency of the breach, the type and/or quantity of information exposed, etc.), and the like;
Optionally, providing, to the organization a report comprising one or more of:
   The determined organizational score
   One or more of the organizational employee scores, and
   For each vendor in the vendor list, a vendor score associated with that vendor; and
Optionally, using the organization score as a vendor score for a company that relies on the organization as a vendor.

Although the aforementioned method has been described to be performed by the privacy risk management platform 100, it should be understood that computing device 400 may be used to perform the various stages of the method. Furthermore, in some embodiments, different operations may be performed by different networked elements in operative communication with computing device 400. For example, a plurality of computing devices may be employed in the performance of some or all of the stages in the aforementioned method. Moreover, a plurality of computing devices may be configured much like a single computing device 400. Similarly, an apparatus may be employed in the performance of some or all stages in the method. The apparatus may also be configured much like computing device 400.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

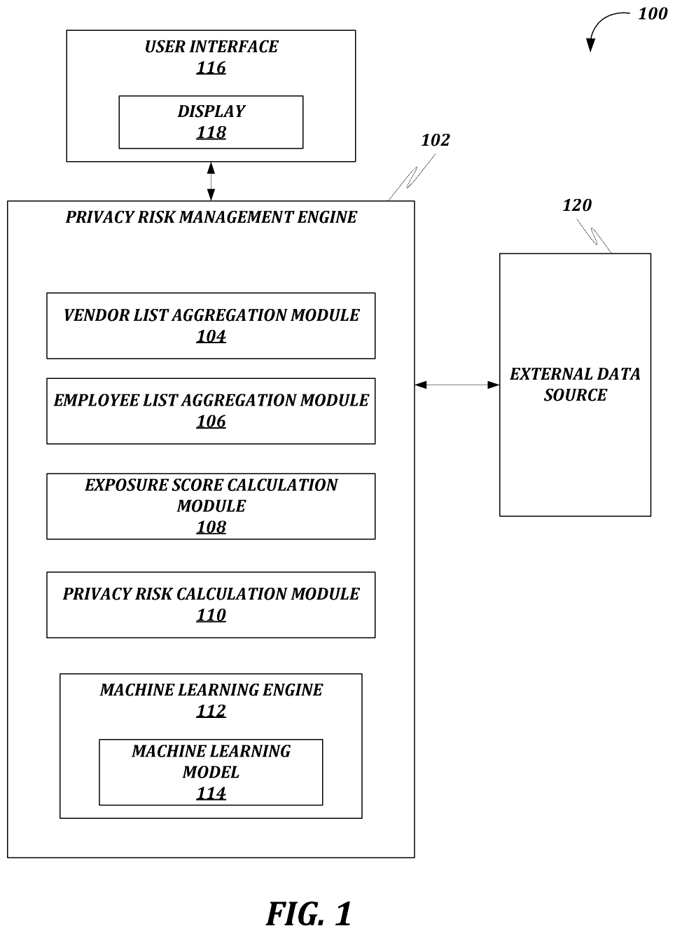

FIG. 1 illustrates one possible operating environment through which a platform consistent with embodiments of the present disclosure may be provided. By way of non-limiting example, a privacy risk management platform 100 may be hosted on, for example, a cloud computing service. In some embodiments, the platform 100 may be hosted on a computing device 400. A user may access platform 100 through a software application and/or hardware device. The software application may be embodied as, for example, but not be limited to, a website, a web application, a desktop application, and a mobile application compatible with the computing device 400.

In embodiments, the platform 100 may include a privacy risk management engine 102. a user interface 116, an external data source 120, and various components thereof. In one or more embodiments, the platform 100 may include more or fewer components than the components illustrated in FIG. 1. The components illustrated in FIG. 1 may be local to or remote from each other.

In one or more embodiments, the user interface 116 refers to hardware and/or software configured to facilitate communications between a user and the privacy risk management engine 102. The user interface 116 may be used by a user who accesses an interface (e.g., a dashboard interface). The user interface 116 may be associated with one or more devices for presenting visual media, such as a display 118, including a monitor, a television, a projector, and/or the like. User interface 116 renders user interface elements and receives input via user interface elements. Examples of interfaces include (but at not limited to) a graphical user interface (GUI), a command line interface (CLI), a haptic interface, and a voice command interface. Examples of user interface elements include, as non-limiting examples, checkboxes, radio buttons, menus, dropdown lists, list boxes, buttons, toggles, text fields, date and time selectors, command lines, sliders, pages, and forms.

Accordingly, embodiments of the present disclosure provide a software and hardware platform comprised of a distributed set of computing elements, including, but not limited to:

### A. A Vendor List Aggregation Module

A vendor list aggregation module 104 may refer to hardware and/or software configured to perform operations described herein (including such operations as may be incorporated by reference) for determining a list of vendors that service a particular organization. In some embodiments, the vendor list aggregation module may determine a list of vendors that have access to one or more computer systems operated by the organization and/or that store private information maintained by the organization.

### B. An Employee List Aggregation Module

An employee list aggregation module 106 may refer to hardware and/or software configured to perform operations described herein (including such operations as may be incorporated by reference) for determining a total number of employees that work for an input organization and/or a list of those employees.

### C. An Employee Exposure Score Calculation Module

An employee exposure score calculation module 108 may refer to hardware and/or software configured to perform operations described herein (including such operations as may be incorporated by reference) for computing an exposure score for a particular employee. In embodiments, the exposure score may be indicative of an exposure of personal information of the employee online. For example, the exposure score may indicate a number of data repositories in which private information (e.g., PII) associated with the employee appears.

### D. A Business Privacy Risk Score Calculation Module

A business privacy risk score calculation module 110 may refer to hardware and/or software configured to perform operations described herein (including such operations as may be incorporated by reference) for determining a business privacy score based at least in part on the scored of the vendors that service the business and the scores of the employees of the business.

### E. An Artificial Intelligence Module

In some embodiments, one or more components of the privacy risk management engine 102 use an artificial intelligence, such as a machine learning engine 112. In particular, the machine learning engine 112 may be used to determine an exposure score for an employee based on information discovered related to the employee (e.g., by the employee exposure score calculation module 108) and/or to calculate a business risk score (e.g., by the business privacy risk score calculation module 110). Machine learning includes various techniques in the field of artificial intelligence that deal with computer-implemented, user-independent processes for solving problems that have variable inputs.

In some embodiments, the machine learning engine 112 trains a machine learning model 114 to perform one or more operations. Training a machine learning model 114 uses training data to generate a function that, given one or more inputs to the machine learning model 114, computes a corresponding output. The output may correspond to a prediction based on prior machine learning. In an embodiment, the output includes a label, classification, and/or categorization assigned to the provided input(s). The machine learning model 114 corresponds to a learned model for performing the desired operation(s) (e.g., labeling, classifying, and/or categorizing inputs). The privacy risk management engine 102 may use multiple machine learning engines 112 and/or multiple machine learning models 114 for different purposes.

In an embodiment, the machine learning engine 112 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 112 receives positive and/or negative reinforcement in the process of attempting to solve a particular problem (e.g., to optimize performance in a particular scenario, according to one or more predefined performance criteria). One example of a network for use in reinforcement learning is a recurrent neural network, which may include a backpropagation or feedback pathway to correct or improve the response of the network.

In an embodiment, a machine learning engine 112 may use many different techniques to label, classify, and/or categorize inputs. A machine learning engine 112 may transform inputs (e.g., the extracted network features) into feature vectors that describe one or more properties (“features”) of the inputs. The machine learning engine 112 may label, classify, and/or categorize the inputs based on the feature vectors. Alternatively or additionally, a machine learning engine 112 may use clustering (also referred to as cluster analysis) to identify commonalities in the inputs. The machine learning engine 112 may group (i.e., cluster) the inputs based on those commonalities. The machine learning engine 112 may use hierarchical clustering, k-means clustering, and/or another clustering method or combination thereof. For example, the machine learning engine 112 may receive, as inputs, one or more data repositories that store data associated with a user, and may calculate an exposure score based on commonalities between the data repositories that store the data, the quantity of data stored at each repository, and/or the types of data stored at each repository. In an embodiment, a machine learning engine 112 may include an artificial neural network. An artificial neural network includes multiple nodes (also referred to as artificial neurons) and edges between nodes. Edges may be associated with corresponding weights that represent the strengths of connections between nodes, which the machine learning engine 112 adjusts as machine learning proceeds. Alternatively or additionally, a machine learning engine 112 may include a support vector machine. A support vector machine represents inputs as vectors. The machine learning engine 112 may label, classify, and/or categorizes inputs based on the vectors. Alternatively or additionally, the machine learning engine 112 may use a naïve Bayes classifier to label, classify, and/or categorize inputs. Alternatively or additionally, given a particular input, a machine learning model may apply a decision tree to predict an output for the given input. Alternatively or additionally, a machine learning engine 112 may apply fuzzy logic in situations where labeling, classifying, and/or categorizing an input among a fixed set of mutually exclusive options is impossible or impractical. The aforementioned machine learning model 114 and techniques are discussed for exemplary purposes only and should not be construed as limiting one or more embodiments.

In an embodiment, as a machine learning engine 112 applies different inputs to a machine learning model 114, the corresponding outputs are not always accurate. As an example, the machine learning engine 112 may use supervised learning to train a machine learning model 114. After training the machine learning model 114, if a subsequent input is identical to an input that was included in labeled training data and the output is identical to the supervisory signal in the training data, then output is certain to be accurate. If an input is different from inputs that were included in labeled training data, then the machine learning engine 112 may generate a corresponding output that is inaccurate or of uncertain accuracy. In addition to producing a particular output for a given input, the machine learning engine 112 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In an embodiment, the privacy risk management engine 102 is configured to receive data from one or more external data sources 120. An external data source 120 refers to hardware and/or software operating independent of the entity classification and data risk assessment engine 102. For example, the hardware and/or software of the external data source 120 may be under control of a different entity (e.g., a different company or other kind of organization) than an entity that controls the entity classification and data risk assessment engine. An external data source 120 may include, for example, one or more network-accessible data repositories, one or more internet scraper applications, one or more networks owned by the particular company, and/or any other third party data source.

In an embodiment, the privacy risk management engine 102 is configured to retrieve data from an external data source 120 by ‘pulling’ the data via an application programming interface (API) of the external data source 120, using user credentials that a user has provided for that particular external data source 120. Alternatively or additionally, an external data source 120 may be configured to ‘push’ data to the privacy risk management engine 102 via an API of the privacy risk management platform 100, using an access key, password, and/or other kind of credential that a user has supplied to the external data source 120. privacy risk management engine 102 may be configured to receive data from an external data source 120 in many different ways.

### III. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method. The method may comprise the following stages:

Initially, the platform may determine, for an organization, a vendor list comprising one or more vendors working with the organization, and an organizational employee list comprising all organization employees. In embodiments, the vendor list for the organization may include all vendors who service the organization, all vendors with an account that allows the vendor to access a computer system maintained by the organization, all vendors with access to PII maintained by the organization, and/or any other subset of vendors that service the organization. The organizational employee list may include all salaried or hourly workers, contractors, and/or other staff (collectively, employees) who work for the organization, all employees who have access to a computer system owned and/or maintained by the organization, all employees with access to organizational PII, and/or any other subset of employees.

For each particular vendor on the vendor list, the platform may populate a vendor employee list comprising a subset of the employees of the particular vendor. In embodiments the subset may include one or more employees of the vendor. The subset may be based on, for example, a listing of employees with an account on the platform, a random or pseudorandom sampling of vendor employees, a list of a subset of vendor employees that is accessible via the platform, a list of vendor employees obtained from an organization that employs the vendor, and/or any other sampling of vendor employees. For each vendor employee in the vendor employee list, the platform may calculate an exposure score associated with the vendor employee. The exposure score may be a qualitative or quantitative score indicative of an exposure of personal information of the vendor employee online. For example, the score may qualitatively or quantitatively indicate the extent to which PII associated with the vendor employee is accessible online, the amount (quantity) and type (quality) of PII associated with the vendor employee available online, the locations online at which the PII is available, and/or other factors associated with the PII.

The platform may, for each particular vendor on the vendor list, calculate a vendor score for the particular vendor. In embodiments, the vendor score may represent a qualitative or quantitative risk of a privacy breach associated with the vendor online. The vendor score may be determined based at least in part on the scores of each vendor employee in the vendor employee list. For example, vendors with a higher proportion of vendor employees having a high-risk score may in turn be higher-risk vendors to work with. In embodiments, the score may be weighted such that those vendor employees with more access to vendor data and/or organizational data maintained by the vendor contribute more to the vendor score. In some embodiments, additional factors such as (but not limited to) evaluation of a privacy policy associated with the vendor, factors associated with prior privacy breaches of the vendor (e.g., recency of the breach, the type and/or quantity of information exposed, etc.), a total number of vendor employees, and/or the like may be taken into account when determining the vendor score.

For each organizational employee in the organizational employee list, the platform may determine an exposure score associated with the organizational employee. As with vendor employees, the exposure score may be a qualitative or quantitative indicator of an exposure of personal information of the organizational employee online. For example, the score may indicate the extent to which PII associated with the organizational employee is accessible online, the amount (quantity) and type (quality) of PII associated with the organizational employee available online, the locations online at which the PII is available, and/or other factors associated with the PII.

The platform may calculate an organization score representing, qualitatively or quantitatively, a risk of a privacy breach associated with (e.g., for information maintained by, stored by, related to, etc.) the organization online. The organization score may be determined based at least in part on the scores of each organizational employee in the organizational employee list. In embodiments, the score may be weighted such that those with more access to organizational information contribute more to the organizational score. In some embodiments, additional factors such as (but not limited to) evaluation of a privacy policy associated with the organization, factors associated with prior privacy breaches of the organization (e.g., recency of the breach, the type and/or quantity of information exposed, etc.), scores of one or more vendor associated with the organization, and/or the like may be taken into account when determining the organizational score.

Those of skill in the art will appreciate that, while developing the organizational score is important, that each organization may act as a vendor for other companies. Accordingly, the organization score may be used as a vendor score for a company that relies on the organization as a vendor.

In some embodiments, the platform may provide, to the organization, a report comprising one or more of, the organizational score, the scores of one or more (e.g., each) organizational employee on the organizational employee list, and/or the scores of each vendor on the vendor list. The scores of one or more (e.g., each) of the vendor employees may be used in calculation of the vendor score, but omitted from the report.

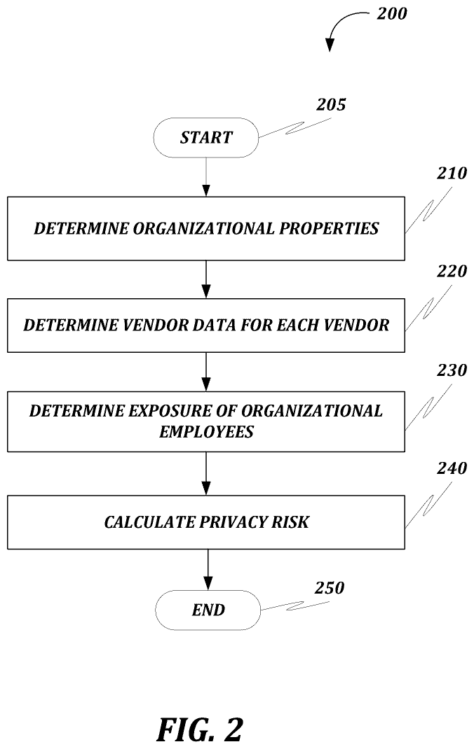

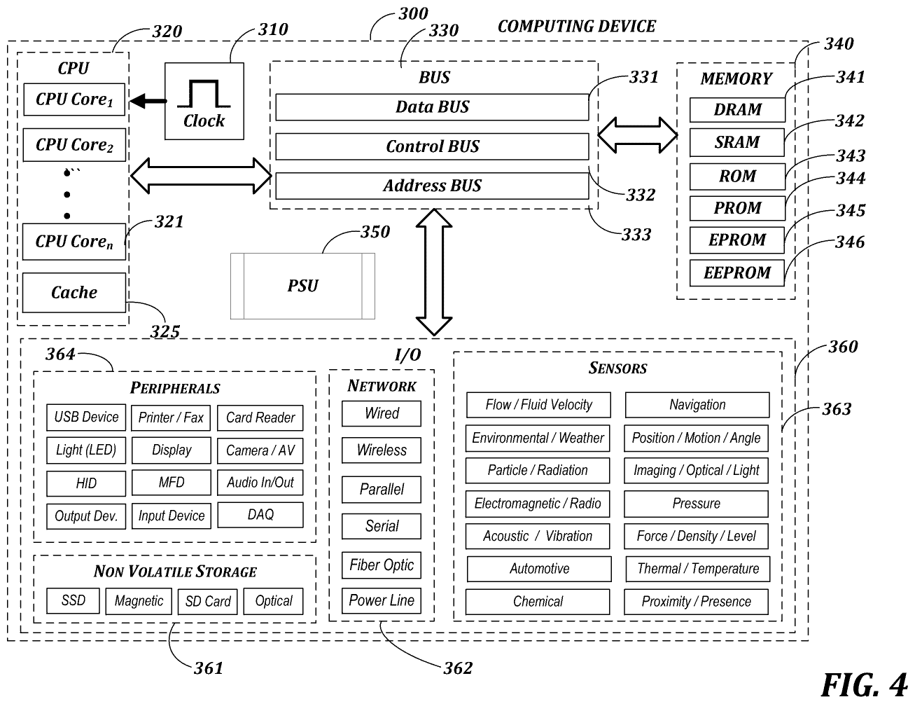

FIG. 2 is a flow chart setting forth the general stages involved in a method 200 consistent with an embodiment of the disclosure for providing privacy risk management platform 100. Method 200 may be implemented using a computing device 400 or any other component associated with platform 100 as described in more detail below with respect to FIG. 4. For illustrative purposes alone, computing device 400 is described as one potential actor in the following stages.

Method 200 may begin at starting block 205 and proceed to stage 210 where computing device 400 may determine properties of an organization. For example, the computing device may determine a quantity of PII maintained by the organization, a sensitivity of the maintained PII (e.g., a list of social security numbers may be viewed as more sensitive than a list of addresses), one or more vendors that work with or otherwise service the organization, one or more organizational employees, and/or other organizational properties. As a particular example, the computing device may determine a vendor list comprising one or more vendors working with the organization, and an organizational employee list comprising all organization employees. In embodiments, the vendor list for the organization may include all vendors who service the organization, all vendors with an account that allows the vendor to access a computer system maintained by the organization, all vendors with access to PII maintained by the organization, and/or any other subset of vendors that service the organization. The organizational employee list may include all salaried and/or hourly workers, exempt and/or non-exempt employees, contractors, and/or other staff (collectively, employees) who work for the organization, all employees who have access to a computer system owned and/or maintained by the organization, all employees with access to organizational PII, and/or any other subset of employees.

From stage 210, where computing device 400 determines organizational data, method 200 may advance to stage 220 where computing device 400 may determine vendor data for each vendor listed in the vendor list. For example, the vendor data may include determining a vendor employee list containing at least a subset (e.g., one or more) employees at the particular vendor. In some embodiments, the vendor employees may be defined in the same way as the organizational employees. Alternatively, the vendor employees may have a different definition from that of the organizational employees. The vendor employee list may include all salaried or hourly workers, all exempt and/or non-exempt employees, contractors, and/or other staff (collectively, employees) who work for the vendor, all vendor employees who have access to a computer system owned and/or maintained by the vendor, all vendor employees with access to PII associated with the organization serviced by the vendor, all vendor employees with access to computer systems maintained by the organization serviced by the vendor, and/or any other subset of employees.

The determined vendor employee list comprising a subset of one or more of the employees of the particular vendor. The subset may be based on, as a non-limiting example, a listing of employees with an account on the privacy risk management platform, a random or pseudorandom sampling of vendor employees, a list of a subset of vendor employees that is accessible via the platform, a list of vendor employees that already have accounts on the platform 100, and/or any other sampling of vendor employees.

In embodiments, the computing device may calculate an exposure score associated with each vendor employee in the vendor employee list. The score may be a qualitative score (e.g., and indication of low, medium, or high risk) or a quantitative score (e.g., a rating from 1-100). The exposure score may be indicative of an exposure of personal information of the vendor employee online. For example, the score may indicate the extent to which PII associated with the vendor employee is accessible online, the amount (quantity) and/or type (quality) of PII associated with the vendor employee available online, the locations online at which the PII is available (e.g., people search sites, dark web, etc.), and/or other factors associated with the PII. In embodiments, determining the exposure score may comprise performing one or more operations to determine PII associated with the vendor employee that is available online (e.g., in an internet-accessible data repository). The steps may include using the vendor employee information from the vendor employee list as inputs to one or more internet search and/or scraping applications to search a plurality of internet-accessible data repositories and/or other internet locations for the information associated with the vendor employee (e.g., by using a web scraper application). In embodiments, the computing device may determine what information related to the vendor employee is found (e.g., names, addresses, family members, credit card numbers, password information, social security numbers or other government identifying information, etc.), in how many of the data repositories the information is found, and in which particular repositories the information is found. The type and/or amount of PII found and/or the location(s) of the PII may be used to determine and assign the exposure score.

In embodiments, the determined vendor information may include a vendor score calculated for the particular vendor. In embodiments, the vendor score may represent a risk of, for example, information security system intrusion, hack, extorsion, ransomware, social engineering attacks, and/or the like. As a particular example, the vendor score may indicate a risk that the vendor will experience a data breach or privacy breach in the future (e.g., in the next year, next 2 years, etc.). In embodiments, the score may be qualitative (e.g., a color rating, a low/medium/high risk rating, a secure/not secure indication, or other qualitative indicator) or quantitative (e.g., a numerical score, letter grade, etc.). The vendor score may be determined based at least in part on the scores of each vendor employee in the vendor employee list. For example, vendors with a higher proportion of vendor employees having a high-risk score may in turn be higher-risk vendors to work with. The vendor employee scores may be weighted when calculating the vendor score, such that those vendor employees with more access to vendor data and/or organizational data maintained by the vendor contribute more to the vendor score. In some embodiments, additional factors such as (but not limited to) evaluation of a privacy policy associated with the vendor, historical data associated with prior privacy breaches of the vendor (e.g., recency of the breach, the type and/or quantity of information exposed, etc.), a total number of vendor employees, and/or the like may be taken into account when determining the vendor score. In some embodiments, one or more (e.g., each) of the vendor employee scores may be calculated, but are hidden from view or otherwise obfuscated in an interface presented to a user at the organization.

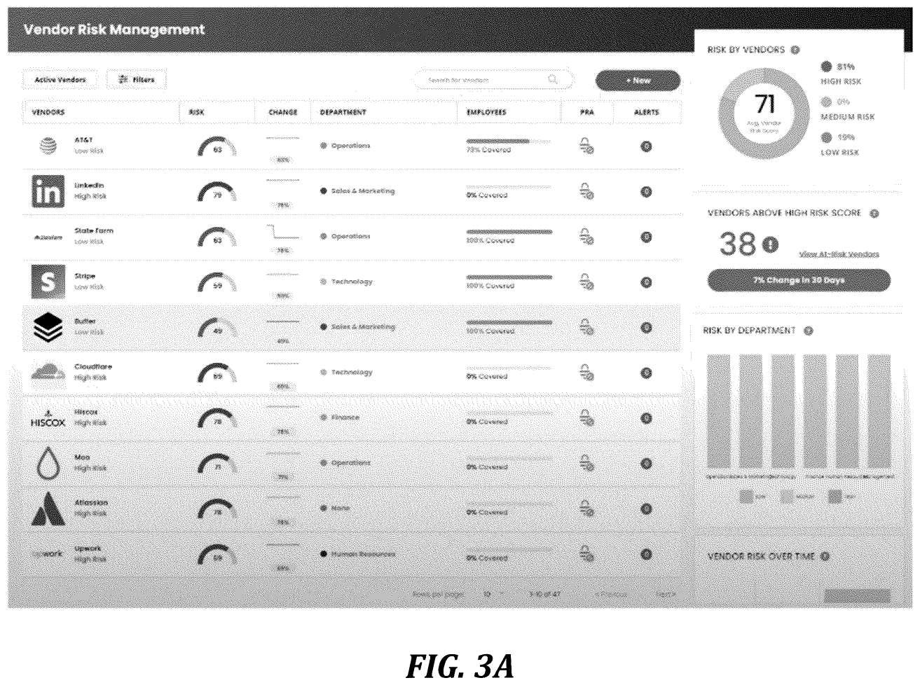

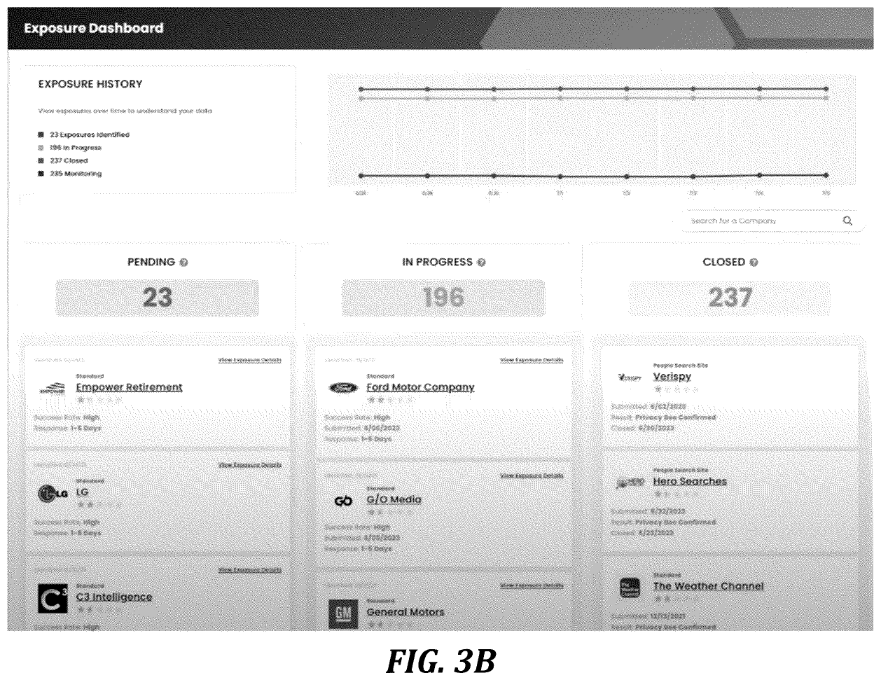

In embodiments, the determining of vendor data in stage 220 may be repeated one or more times, for each of the one or more vendors on the vendor list aggregated in stage 210. In some embodiments, as shown in FIG. 3A, the computing device may provide, to a user an interface showing the calculated vendor risk scores of at least one of the one or more vendors. Once the vendor information has been determined for each of the vendors in the vendor list, the method 200 may proceed to stage 230.

In stage 230, the computing device 400 may determine, for each organizational employee in the organizational employee list, an exposure score associated with the organizational employee. In some embodiments, the exposure score may be indicative of an exposure of personal information of the organizational employee online. For example, the score may indicate the extent to which PII associated with the organizational employee is accessible online, the amount (quantity) and type (quality) of PII associated with the organizational employee available online, the locations online at which the PII is available (e.g., people search sites, dark web, etc.), and/or other factors associated with the PII. In embodiments, determining the exposure score may comprise performing one or more operations to determine PII associated with the organizational employee that is available online (e.g., in an internet-accessible data repository, a people search site, the dark web, etc.). The steps may include determining information associated with the organizational employee (e.g., by using the organizational employee name and/or any other organizational employee information), using the determined information as inputs to one or more internet search and/or scraping applications to search a plurality of internet-accessible data repositories for the information associated with the organizational employee (e.g., by using a web scraper application), and determining what information related to the organizational employee is found (e.g., names, addresses, family members, credit card numbers, password information, social security numbers or other government identifying information, etc.), in how many of the data repositories the information is found, and in which particular repositories the information is found. The quantity and/or quality of the PII found and/or the location(s) of the PII may be used to determine and assign the exposure score.

The stage 230 of calculating the organizational employee scores may be repeated one or more times, for each of the one or more organizational employees on the organizational employee list aggregated in stage 210. Once the organizational employee exposure scores have been determined for each of the organizational employees, the method 200 may proceed to stage 240. In some embodiments the computing device may provide, to a user an interface showing the calculated organizational employee risk scores for one or more (e.g., each) of the one or more organizational employees.

In some embodiments, responsive to determining that PII associated with a particular employee on the organizational employee list has been located within at least one internet-accessible data repository, the computing device may transmit, to at least one of the internet-accessible data repositories that include the determined demographic information associated with the particular employee, a request to remove the determined demographic information. Transmitting the request may include, for example, transmitting an electronic message, such as (but not limited to) an email, to an address associated with the data repository. Additionally or alternatively, the computing device may transmit the request as one or more instructions to the data repository, via an Application Programming Interface (API). The computing device may receive, from the internet-accessible data repository, an indication that the determined demographic information associated with the organizational employee has been removed. Responsive to the indication that the determined demographic information is removed, the computing device may recalculate the exposure score for the employee.

In some embodiments, as shown in FIG. 3B, the computing device may optionally provide a graphical interface to one or more (e.g., each) organizational employee. The graphical interface may include (but need not be limited to) elements that display at least one of the one or more internet-accessible data repositories in which the information associated with the organizational employee was found. For at least one of the one or more internet-accessible data repositories in which the determined information was found, the interface may include instructions for removing the determined information from the data repository. In some embodiments the interface may further specify what information was found in each of the one or more repositories. In some embodiments, the interface may include the exposure score associated with the organizational employee, generated in stage 230.

In stage 240, the computing device 400 may calculate an organization score. In particular, the organization score may represent a risk of, for example, information security system intrusion, hack, extorsion, ransomware, social engineering attacks, and/or the like. As a particular example, the organization score may indicate a risk that the organization will experience a data breach or privacy breach in the future (e.g., in the next year, next 2 years, etc.). In embodiments, the organization score may be qualitative (e.g., a color rating, a low/medium/high risk rating, a secure/not secure indication, or other qualitative indicator) or quantitative (e.g., a numerical score, letter grade, etc.). The organization score may be determined based at least in part the scores of each organizational employee in the organizational employee list determined in stage 230. For example, an organization that employs organizational employees having higher exposure scores may be at a higher-risk of PII maintained by the vendor being exposed (e.g., through a spear phishing style attack, social engineering tactic, or other similar privacy attack). In some embodiments, the organizational score may additionally be determined based at least in part on the one or more vendor scores associated with each of the one or more vendors on the vendor list determined in stage 220. That is, an organization that is serviced by vendors with a higher risk score may in turn be at a higher-risk of PII maintained by the vendor being exposed (e.g., through a spear phishing style attack, social engineering tactic, or other similar privacy attack). The vendor scores and/or the organizational employee scores may be weighted when calculating the organization score, such that those vendors and/or organizational employees with more access to organizational data contribute more to the vendor score. In some embodiments, additional factors such as (but not limited to) evaluation of a privacy policy associated with the organization, historical data associated with prior privacy breaches of the organization (e.g., recency of the breach, the type and/or quantity of information exposed, etc.), a total number of organizational employees, and/or the like may be taken into account when determining the organization score.

In some embodiments, where one or more organizational employee scores are recalculated in stage 230 responsive to the indication that the determined demographic information is removed, the computing device may recalculate the organizational score for organization based on the recalculated exposure score for the one or more particular employees. In some embodiments the computing device may provide, to a user an interface showing the calculated organizational score. In embodiment, the interface may omit or otherwise obfuscate at least the one or more vendor employee scores used in calculating the vendor scores that are in turn used to calculate the organizational score.

Those of skill in the art will appreciate that, while developing the organizational score is important, that each organization may act as a vendor for other companies. Accordingly, the organization score may be used as a vendor score for a company that relies on the organization as a vendor.

Once computing device 400 calculates the organizational privacy risk in stage 240, method 200 may then end at stage 250.

### Hardware Configuration

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 400. The computing device 400 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
Platform 100 may be hosted on a centralized server or a cloud computing service. Although method 200 has been described to be performed by a computing device 400, it should be understood that, in some embodiments, different operations may be performed by a plurality of the computing devices 400 in operative communication on at least one network.

Embodiments of the present disclosure may comprise a system having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for redundancy, high availability, and/or performance purposes. The combination of the presently disclosed units is configured to perform the stages of any method disclosed herein.

FIG. 4 is a block diagram of a system including computing device 400. Consistent with an embodiment of the disclosure, the aforementioned CPU 420, the bus 430, the memory unit 440, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, and the memory unit 440, consistent with embodiments of the disclosure.

At least one computing device 400 may be embodied as any of the computing elements illustrated in all of the attached figures. A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In some configurations, the computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

In a system consistent with an embodiment of the disclosure, the computing device 400 may include the clock module 410, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 420, the central component of modern computers, which relies on a clock signal. The clock 410 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 400 may use a “clock multiplier” which multiplies a lower frequency external clock to the appropriate clock rate of the CPU 420. This allows the CPU 420 to operate at a much higher frequency than the rest of the computing device 400, which affords performance gains in situations where the CPU 420 does not need to wait on an external factor (like memory 440 or input/output 460). Some embodiments of the clock 410 may include dynamic frequency change, where, the time between clock edges can vary widely from one edge to the next and back again.

In a system consistent with an embodiment of the disclosure, the computing device 400 may include the CPU 420 comprising at least one CPU Core 421. In other embodiments, the CPU 420 may include a plurality of identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU 420 reads and executes program instructions which may be used across many application domains, for example, but not limited to, general purpose computing, embedded computing, network computing, digital signal processing (DSP), and graphics processing (GPU). The CPU 420 may run multiple instructions on separate CPU cores 421 simultaneously. The CPU 420 may be integrated into at least one of a single integrated circuit die, and multiple dies in a single chip package. The single integrated circuit die and/or the multiple dies in a single chip package may contain a plurality of other elements of the computing device 400, for example, but not limited to, the clock 410, the bus 430, the memory 440, and I/O 460.

The CPU 420 may contain cache 422 such as but not limited to a level 1 cache, a level 2 cache, a level 3 cache, or combinations thereof. The cache 422 may or may not be shared amongst a plurality of CPU cores 421. The cache 422 sharing may comprise at least one of message passing and inter-core communication methods used for the at least one CPU Core 421 to communicate with the cache 422. The inter-core communication methods may comprise, but not be limited to, bus, ring, two-dimensional mesh, and crossbar. The aforementioned CPU 420 may employ symmetric multiprocessing (SMP) design.

The one or more CPU cores 421 may comprise soft microprocessor cores on a single field programmable gate array (FPGA), such as semiconductor intellectual property cores (IP Core). The architectures of the one or more CPU cores 421 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the computing device 400, and/or the plurality of computing devices 400. The aforementioned communication system will be known to a person having ordinary skill in the art as a bus 430. The bus 430 may embody internal and/or external hardware and software components, for example, but not limited to a wire, an optical fiber, various communication protocols, and/or any physical arrangement that provides the same logical function as a parallel electrical bus. The bus 430 may comprise at least one of a parallel bus, wherein the parallel bus carries data words in parallel on multiple wires; and a serial bus, wherein the serial bus carries data in bit-wise serial form. The bus 430 may embody a plurality of topologies, for example, but not limited to, a multidrop/electrical parallel topology, a daisy chain topology, and connected by switched hubs, such as a USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, known to persons having ordinary skill in the art as primary storage or memory 440. The memory 440 operates at high speed, distinguishing it from the non-volatile storage sub-module 461, which may be referred to as secondary or tertiary storage, which provides relatively slower-access to information but offers higher storage capacity. The data contained in memory 440, may be transferred to secondary storage via techniques such as, but not limited to, virtual memory and swap. The memory 440 may be associated with addressable semiconductor memory, such as integrated circuits consisting of silicon-based transistors, that may be used as primary storage or for other purposes in the computing device 400. The memory 440 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 400 may employ a communication system between an information processing system, such as the computing device 400, and the outside world, for example, but not limited to, human, environment, and another computing device 400. The aforementioned communication system may be known to a person having ordinary skill in the art as an Input/Output (I/O) module 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces with a plurality of hardware, such as, but not limited to, non-volatile storage 461, communication devices 462, sensors 463, and peripherals 464. The plurality of hardware is used by at least one of, but not limited to, humans, the environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ a non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 may not lose data when power is removed and may be orders of magnitude less costly than storage used in memory 440. Further, the non-volatile storage sub-module 461 may have a slower speed and higher latency than in other areas of the computing device 400. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD±RW/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 400 may employ a communication sub-module 462 as a subset of the I/O module 460, which may be referred to by a person having ordinary skill in the art as at least one of, but not limited to, a computer network, a data network, and a network. The network may allow computing devices 400 to exchange data using connections, which may also be known to a person having ordinary skill in the art as data links, which may include data links between network nodes. The nodes may comprise networked computer devices 400 that may be configured to originate, route, and/or terminate data. The nodes may be identified by network addresses and may include a plurality of hosts consistent with the embodiments of a computing device 400. Examples of computing devices that may include a communication sub-module 462 include, but are not limited to, personal computers, phones, servers, drones, and networking devices such as, but not limited to, hubs, switches, routers, modems, and firewalls.

Two nodes can be considered networked together when one computing device 400 can exchange information with the other computing device 400, regardless of any direct connection between the two computing devices 400. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 462 may comprise a plurality of size, topology, traffic control mechanisms and organizational intent policies. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 400 may employ a sensors sub-module 463 as a subset of the I/O 460. The sensors sub-module 463 comprises at least one of the device, module, or subsystem whose purpose is to detect events or changes in its environment and send the information to the computing device 400. Sensors may be sensitive to the property they are configured to measure, may not be sensitive to any property not measured but be encountered in its application, and may not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ a peripherals sub-module 464 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 400. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 400 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting stage lighting, architectural lighting, special effect lighting, and lasers.
   Other devices such as Digital to Analog Converter (DAC)·
Input/Output Devices may further comprise, but not be limited to, touchscreens, networking devices (e.g., devices disclosed in network sub-module 462), data storage devices (non-volatile storage 461), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### IV. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
determining, for an organization,
a vendor list comprising one or more vendors working with the organization, and
an organizational employee list comprising at least a subset of the organization employees;
for each particular vendor on the vendor list:
populating a vendor employee list comprising at least a subset of the employees of the particular vendor,
calculating, for each vendor employee in the vendor employee list, an exposure score associated with the vendor employee, the exposure score being indicative of an exposure of personal information of the vendor employee online, and
calculating a vendor score for the particular vendor, the vendor score representing a privacy and security risk associated with the vendor online, the vendor score being determined based at least in part on the scores of each vendor employee in the vendor employee list;
for each organizational employee in the organizational employee list, determining an exposure score associated with the organizational employee, the exposure score being indicative of an exposure of personal information of the organizational employee online;
calculating an organization score representing a privacy and security risk associated with the organization online, the organization score being determined based at least on the scores of each organizational employee in the organizational employee list; and
providing, to a user, a report comprising at least one of:
the organization score,
the organizational employee exposure scores or one or more of the organizational employees on the organizational employee list, and
the vendor scores of one or more of the vendors on the vendor list.

2. The method of claim 1, wherein the privacy and security risk associated with the vendor comprises a risk of the vendor being a target of one or more of information security system intrusion, hack, extorsion, ransomware, or social engineering attacks.

3. The method of claim 1, wherein the privacy and security risk associated with the organization comprises a risk of the organization being a target of one or more of information security system intrusion, hack, extorsion, ransomware, or social engineering attacks.

4. The method of claim 1, wherein the vendor score is further based at least on one or more of the following:
a total number of vendor employees;
a privacy policy associated with the vendor, or
historical data associated with a privacy breach involving the vendor.

5. The method of claim 1, wherein the organization score is further based at least on one or more of the following:
a total number of organization employees;
a privacy policy associated with the organization,
historical data associated with a privacy breach involving the organization, or
the vendor scores associated with one or more of the vendors on the vendor list.

6. The method of claim 1, wherein calculating an exposure score associated with a subject employee comprises:
searching a plurality of internet-accessible data repositories for the personal information associated with the employee;
determining a total number of the internet-accessible data repositories that include the personal information; and
assigning an exposure score based at least in part on the determined number of the internet-accessible data repositories that include the determined personal information.

7. The method of claim 6, further comprising:
for a particular employee on the organizational employee list:
transmitting, to at least one of the internet-accessible data repositories that include the personal information associated with the particular employee, a request to remove the personal information;
receiving, from the at least one of the internet-accessible data repositories, an indication that the personal information is removed; and
responsive to the indication that the personal information is removed, recalculating the exposure score for the particular employee.

8. The method of claim 7, further comprising:
responsive to the indication that the personal information is removed, recalculating the organizational score for the organization based on the recalculated exposure score for the particular employee.

9. The method of claim 1, further comprising:
for each particular organizational employee:
displaying, to the particular organizational employee:
the exposure score associated with the particular organizational employee, one or more internet-accessible data repositories in which the personal information associated with the particular organizational employee was found; and
for at least one of the one or more internet-accessible data repositories in which the personal information associated with the particular organizational employee was found, instructions for removing the personal information associated with the particular organizational employee from the data repository.

10. A system comprising:
at least one device including a hardware processor;
the system being configured to perform operations comprising:
determining, for an organization,
a vendor list comprising one or more vendors working with the organization, and
an organizational employee list comprising at least a subset of the organization employees;
for each particular vendor on the vendor list:
populating a vendor employee list comprising at least a subset of the employees of the particular vendor,
calculating, for each vendor employee in the vendor employee list, an exposure score associated with the vendor employee, the exposure score being indicative of an exposure of personal information of the vendor employee online, and
calculating a vendor score for the particular vendor, the vendor score representing a privacy and security risk associated with the vendor online, the vendor score being determined based at least in part on the scores of each vendor employee in the vendor employee list;
for each organizational employee in the organizational employee list, determining an exposure score associated with the organizational employee, the exposure score being indicative of an exposure of personal information of the organizational employee online;
calculating an organization score representing a privacy and security risk associated with the organization online, the organization score being determined based at least on the scores of each organizational employee in the organizational employee list; and
providing, to a user, a report comprising at least one of:
the organization score,
the organizational employee exposure scores or one or more of the organizational employees on the organizational employee list, and
the vendor scores of one or more of the vendors on the vendor list.

11. The system of claim 10, wherein the privacy and security risk associated with the vendor comprises a risk of the vendor being a target of one or more of information security system intrusion, hack, extorsion, ransomware, or social engineering attacks.

12. The system of claim 10, wherein the privacy and security risk associated with the organization comprises a risk of the organization being a target of one or more of information security system intrusion, hack, extorsion, ransomware, or social engineering attacks.

13. The system of claim 10, wherein the vendor score is further based at least on one or more of the following:
a total number of vendor employees;
a privacy policy associated with the vendor, or
historical data associated with a privacy breach involving the vendor.

14. The system of claim 10, wherein the organization score is further based at least on one or more of the following:
a total number of organization employees;
a privacy policy associated with the organization,
historical data associated with a privacy breach involving the organization, or
the vendor scores associated with one or more of the vendors on the vendor list.

15. The system of claim 10, wherein calculating an exposure score associated with a subject employee comprises:
searching a plurality of internet-accessible data repositories for the personal information associated with the employee;
determining a total number of the internet-accessible data repositories that include the personal information; and
assigning an exposure score based at least in part on the determined number of the internet-accessible data repositories that include the determined personal information.

16. The system of claim 15, the operations further comprising:
for a particular employee on the organizational employee list:
transmitting, to at least one of the internet-accessible data repositories that include the personal information associated with the particular employee, a request to remove the personal information;
receiving, from the at least one of the internet-accessible data repositories, an indication that the personal information is removed; and
responsive to the indication that the personal information is removed, recalculating the exposure score for the particular employee.

17. The system of claim 16, the operations further comprising:
responsive to the indication that the personal information is removed, recalculating the organizational score for the organization based on the recalculated exposure score for the particular employee.

18. The system of claim 10, the operations further comprising:
for each particular organizational employee:
displaying, to the particular organizational employee:
the exposure score associated with the particular organizational employee,
one or more internet-accessible data repositories in which the personal information associated with the particular organizational employee was found; and
for at least one of the one or more internet-accessible data repositories in which the personal information associated with the particular organizational employee was found, instructions for removing the personal information associated with the particular organizational employee from the data repository.

19. One or more non-transitory computer readable media comprising instructions which, when executed by one or more hardware processors, causes performance of operations comprising:
determining, for an organization,
a vendor list comprising one or more vendors working with the organization, and
an organizational employee list comprising at least a subset of the organization employees;
for each particular vendor on the vendor list:
populating a vendor employee list comprising at least a subset of the employees of the particular vendor,
calculating, for each vendor employee in the vendor employee list, an exposure score associated with the vendor employee, the exposure score being indicative of an exposure of personal information of the vendor employee online, and
calculating a vendor score for the particular vendor, the vendor score representing a privacy and security risk associated with the vendor online, the vendor score being determined based at least in part on the scores of each vendor employee in the vendor employee list;
for each organizational employee in the organizational employee list, determining an exposure score associated with the organizational employee, the exposure score being indicative of an exposure of personal information of the organizational employee online;
calculating an organization score representing a privacy and security risk associated with the organization online, the organization score being determined based at least on the scores of each organizational employee in the organizational employee list; and
providing, to a user, a report comprising at least one of:
the organization score,
the organizational employee exposure scores or one or more of the organizational employees on the organizational employee list, and
the vendor scores of one or more of the vendors on the vendor list.

20. The computer-readable media of claim 19, wherein the privacy and security risk associated with the organization comprises a risk of the organization being a target of one or more of information security system intrusion, hack, extorsion, ransomware, or social engineering attacks.
